(19) United States
(12) Patent Application Publication
(10) Pub. No.: US 2006/0087291 A1
(43) Pub. Date: Apr. 27, 2006

(54) Method of controlling rechargeable battery power and a power source apparatus

(76) Inventor: Yutaka Yamauchi, Himeji-city (JP)

Correspondence Address: WENDEROTH, LIND & PONACK, L.L.P., 2033 K STREET N. W., SUITE 800, WASHINGTON, DC, 20006-1021, US

(21) Appl. No.: 11/259,099

(22) Filed: Oct. 27, 2005

(30) Foreign Application Priority Data
Oct. 24, 2004 (JP) 313242/2004

(51) Int. Cl. H02J 7/00

(52) U.S. Cl. 320/137

(57) ABSTRACT

The method of controlling rechargeable battery power is a method that includes limiting the amount of usable power during rechargeable battery charging and discharging, determining a rechargeable battery current-voltage characteristic function based on rechargeable battery charging and discharging current flow and voltage, finding a limiting discharging current Iₘₐₓ and/or a limiting charging current Iₘᵢₙ from a prescribed minimum voltage Vₘᵢₙ to prevent over-discharging and/or a prescribed maximum voltage Vₘₐₓ to prevent over-charging and their intersection with the current-voltage characteristic function, and controlling current such that discharging current greater than or equal to Iₘₐₓ and/or charging current less than or equal to Iₘᵢₙ does not flow through the rechargeable batteries. In this fashion, the amount of usable power can be limited considering factors such as the memory effect, and the rechargeable battery can be used to its maximum capability within the range of safe operation.

### BACKGROUND OF THE INVENTION

1. Field of the Invention

This invention relates to a method of controlling the amount of rechargeable battery power and to a power source apparatus, and for example, relates to a method to limit the amount of electric power from a rechargeable battery included in a power source apparatus for powering a motor to drive a car and to the power source apparatus.

2. Description of the Related Art

A power source apparatus can increase output current by increasing the number of power source modules that connect batteries or battery cells in series or parallel. It can raise output voltage by increasing the number of series connected power source modules. In particular, a configuration that connects a plurality of batteries in series to increase output can be adopted by a power source apparatus used in applications that require high output such as cars or automobiles, bicycles, and tools. For example, a high current, high output power source used in a power source apparatus for a car driven by an electric motor, such as a hybrid car or fuel cell car, has a plurality of batteries connected in series to form power source modules, and those modules are in turn connected in series to increase output voltage. The purpose here is to increase the output of the driving motor.

In this type of power source apparatus, limiting output to utilize batteries under safe conditions is important for continued battery use with high reliability. For example, battery lifetime is reduced if over-discharging or over-charging occurs. Consequently, it is necessary to limit the amount of usable power during battery charging and discharging. However, usable power of a battery varies with remaining battery capacity or state of charge (SOC) of the battery. The remaining battery capacity or SOC is generally determined by subtracting the discharged capacity from the fully charged state. Discharge capacity is calculated by integrating discharge current. Remaining battery capacity is the product of current and time and can be represented in units of ampere-hour (Ah), or as a fraction (in %) of full charge capacity, which is set to 100%. Regardless of the units for representing remaining battery capacity, it is determined by subtracting the discharged capacity from the fully charged state. However, remaining battery capacity determined from the integrated discharge current is not always in agreement with the correct remaining battery capacity. This is because the magnitude of the discharge current and battery temperature are causes of error in determining remaining battery capacity. Correspondingly, accurate determination of remaining battery capacity is difficult, and even when current and voltage are the same, the amount of usable power can be different depending on factors such as remaining battery capacity and battery temperature. In particular, when the commonly described “memory effect” occurs, an actual decrease in battery capacity results, and remaining battery capacity determination becomes even more difficult. The memory effect is a phenomenon that occurs when a battery such as a nickel cadmium battery or nickel hydrogen battery is put through charge-discharge cycles with shallow discharge (low discharge levels not approaching full discharge). When a battery in this condition is deeply discharged, discharge voltage drops temporarily. Because remaining battery capacity changes due to the memory effect, an accurate value of remaining battery capacity cannot be estimated. If remaining battery capacity is not determined accurately, battery over-load can occur during charging and discharging, and this can be a cause of marked reduction in battery lifetime. Meanwhile, change in remaining battery capacity can also result from battery self-discharge. Because of these factors, estimation of remaining battery capacity is difficult, and obtaining an accurate value of remaining battery capacity is extremely problematical.

Taking factors such as the memory effect into consideration, a scheme may be devised to preset the amount of usable power low for safety reasons. However, this sacrifices intrinsic usable power, results in battery use at reduced outputs, and makes it impossible to fully utilize the battery's inherent performance. In contrast, if the amount of usable battery power is set high, charging and discharging may occur at power levels exceeding the actual appropriate usable power and become a cause of reduced battery lifetime (refer to Japanese Patent Application Disclosure SHO 56-126776, 1981).

### SUMMARY OF THE INVENTION

The present invention was developed to solve these types of prior art problems. Thus it is a primary object of the present invention to provide a method of controlling rechargeable battery power and a power source apparatus wherein it is possible to appropriately set the amount of usable battery power corresponding to the state of the battery.

To attain the objective above, the first aspect of the method of controlling rechargeable battery power of the present invention, which is a method that also limits the amount of power used during charging and discharging, is to determine a function relating current and voltage characteristics based on rechargeable battery current flow and voltage during charging and discharging. A prescribed minimum voltage Vₘᵢₙ to prevent over-discharging and/or a prescribed maximum voltage Vₘₐₓ to prevent over-charging are determined, and a limiting discharging current Iₘₐₓ and/or a limiting charging current Iₘᵢₙ are found from intersections with the current-voltage characteristic function of the rechargeable battery. Current flow through the rechargeable battery is controlled such that discharging current greater than or equal to Iₘₐₓ and/or charging current less than or equal to Iₘᵢₙ does not flow. In this fashion, the amount of usable power can be limited considering factors such as the memory effect, and the rechargeable battery can be used to its maximum capability within the range of safe operation.

The second aspect of the method of controlling rechargeable battery power of the present invention, which is a method that also limits the amount of power used during charging and discharging, is to measure current flow I_{L} and voltage V_{L} during charging and discharging, and based on that, calculate rechargeable battery open circuit voltage V_{OC} and internal resistance R₀. From the straight line described by
V_{L}=V_{OCV}−R₀I_{L} (5)
and from a prescribed minimum voltage Vₘᵢₙ to prevent over-discharging and/or a prescribed maximum voltage Vₘₐₓ to prevent over-charging, a limiting discharging current Iₘₐₓ and/or a limiting charging current Iₘᵢₙ are found from intersections on the straight line, and current flow through the rechargeable battery is controlled such that discharging current greater than or equal to Iₘₐₓ and/or charging current less than or equal to Iₘᵢₙ does not flow. In this fashion, the amount of usable power can be limited considering factors such as the memory effect, and the rechargeable battery can be used to its maximum capability within the range of safe operation.

The third aspect of the method of controlling rechargeable battery power of the present invention is to periodically measure discharge voltage V₁ and discharge current I₁ during rechargeable battery discharge, and from the relation
V_{OCV}=V_{L+}R₀I_{L} (6)
obtained from equation (5), update the value of V_{OCV}. From equation (5) reflecting the updated V_{OCV} and from a prescribed minimum voltage Vₘᵢₙ to prevent over-discharging, a limiting discharging current Iₘₐₓ is found from the intersection with Vₘᵢₙ on the straight line, and current flow through the rechargeable battery is controlled such that discharging current greater than or equal to Iₘₐₓ does not flow. In this fashion, since an upper limit on possibly increasing discharging current can be known at each point in time during rechargeable battery discharge, the value of discharging current can be limited within that range allowing rechargeable battery utilization with safety and to the maximum extent possible. In particular, the rechargeable battery can be used safely even when, as a result of discharge conditions, operation is off the straight line described above.

The fourth aspect of the method of controlling rechargeable battery power of the present invention is to periodically measure charging voltage V₂ during charging and discharging current I₁, and update the value of V_{OCV} from equation (6). From equation (5) reflecting the updated V_{OCV} and from a prescribed maximum voltage Vₘₐₓ to prevent over-charging, a limiting charging current Iₘᵢₙ is found from the intersection with Vₘₐₓ on the straight line, and current flow through the rechargeable battery is controlled such that charging current greater than or equal in magnitude to Iₘᵢₙ does not flow. Here, charging current is opposite in polarity from discharging current, and in this patent application discharging current is taken as positive and charging current is negative. Thus, Iₘᵢₙ is a large magnitude negative value. In this fashion, since an upper limit on possibly increasing charging current can be known at each point in time during rechargeable battery charging, the value of charging current can be limited within that range allowing rechargeable battery utilization with safety and to the maximum extent possible. In particular, the rechargeable battery can be used safely even when, as a result of charging conditions, operation is off the straight line described above.

The fifth aspect of the method of controlling rechargeable battery power of the present invention is to compute maximum possible discharging power P_{limd} at any given time from the open circuit voltage V_{OCV} and internal resistance R₀ computed at that time during discharging, and from the equation
P_{limd}=Vₘᵢₙ*(V_{OCV}−Vₘᵢₙ)/R₀. (7)
In this fashion, since an upper limit on the amount of power that can be output can be known at each point in time during rechargeable battery discharging, the amount of discharging power can be limited within that range allowing rechargeable battery discharging with safety and to the maximum extent possible.

The sixth aspect of the method of controlling rechargeable battery power of the present invention is to compute maximum possible charging power P_{limc} at any given time from the open circuit voltage V_{OCV} and internal resistance R₀ computed at that time during charging, and from the equation
P_{limc}=Vₘₐₓ*(Vₘₐₓ−V_{OCV})/R₀. (8)
In this fashion, since an upper limit on the amount of power that the rechargeable battery can be charged with can be known at each point in time during charging, the amount of charging power can be limited within that range allowing rechargeable battery charging with safety and to the maximum extent possible.

The seventh aspect of the method of controlling rechargeable battery power of the present invention is to repeatedly pulse discharge rechargeable batteries a plurality of times when the batteries are not driving connected equipment, to detect discharging current and discharging voltage, and to update the value of rechargeable battery open circuit voltage V_{OCV} and internal resistance R₀ based on the discharging current I_{L} and discharging voltage V_{L}.

Finally, the eighth aspect of a power source apparatus of the present invention is to provide a battery unit 20 having a plurality of rechargeable batteries, a voltage detection section 12 to detect the voltage of rechargeable batteries included in the battery unit 20, a temperature detection section 14 to detect the temperature of rechargeable batteries included in the battery unit 20, a current detection section 16 to detect current flow through rechargeable batteries included in the battery unit 20, a control computation section 18 to operate on signals input from the voltage detection section 12, the temperature detection section 14, and the current detection section 16 and determine rechargeable battery maximum limiting current values, and a communication section 19 to send the remaining capacity and maximum limiting current values computed by the control computation section 18 to the connected equipment. The control computation section 18 determines a function relating current and voltage characteristics based at least on rechargeable battery current flow or voltage during charging and discharging, and determines a limiting discharging current Iₘₐₓ and/or a limiting charging current Iₘᵢₙ from intersections of a prescribed minimum voltage Vₘᵢₙ to prevent over-discharging and/or a prescribed maximum voltage Vₘₐₓ to prevent over-charging with the current-voltage characteristic function. The control computation section 18 controls current flow through the rechargeable battery such that discharging current greater than or equal to Iₘₐₓ and/or charging current less than or equal to Iₘᵢₙ does not flow. In this fashion, the amount of usable power can be limited considering factors such as the memory effect, and the rechargeable battery can be used to its maximum capability within the range of safe operation.

The method of controlling rechargeable battery power and power source apparatus of the present invention can compute the amount of maximum usable power without depending on rechargeable battery remaining capacity. In particular, power control based on remaining capacity can loose accuracy when the estimate of remaining capacity is in error. However, the present invention can perform stable power control regardless of the validity of the remaining capacity estimate, and the power source apparatus can be used effectively with a high degree of reliability.

The above and further objects and features of the invention will more fully be apparent from the following detailed description with accompanying drawings.

### BRIEF DESCRIPTION OF THE DRAWINGS

FIG. 1 is a block diagram showing the structure of a power source apparatus related to one form of an embodiment of the present invention.

FIG. 2 is a circuit diagram showing the relation between battery voltage V_{L} and battery current I_{L}, and internal battery resistance R₀ and open circuit voltage V_{OCV}.

FIG. 3 is a graph showing battery current-voltage characteristics during charging and discharging.

FIG. 4 shows graphs for a method of computing limiting current during discharging; (a) shows a method for determining maximum limiting discharging current Iₘₐₓ when discharging is not taking place; and (b) shows a method for determining maximum limiting discharging current Iₘₐₓ₁ during discharging.

FIG. 5 is a graph showing the case where internal resistance and open circuit voltage are updated during discharging.

FIG. 6 shows graphs for a method of computing limiting current during charging; (a) shows a method for determining the limiting charging current Iₘᵢₙ of maximum magnitude when charging is not taking place; and (b) shows a method for determining the limiting charging current Iₘᵢₙ₁ of maximum magnitude during charging.

FIG. 7 is a graph showing the case where internal resistance and open circuit voltage are updated during charging.

### DETAILED DESCRIPTION OF THE PREFERRED EMBODIMENTS

The following describes forms of embodiments of the present invention based on the drawings. However, the forms of embodiments indicated below are for the purpose of concretely demonstrating technical concepts of the present invention, and the method of controlling rechargeable battery power and power source apparatus of this invention are not limited to the description below. Further, components cited in the claims are in no way specified by components in the forms of embodiments. Components shown in the drawings may have there size or positional relations exaggerated for the purpose of making the description clear. In the description below, components which are the same or are of the same material may be designated by the same name or label, and their detailed description may be suitably abbreviated. In addition, concerning elements that make up the present invention, a plurality of elements comprising the same components may be represented in the form of one component used for a plurality of elements, and conversely the function of one component can also be implemented by a plurality of components.

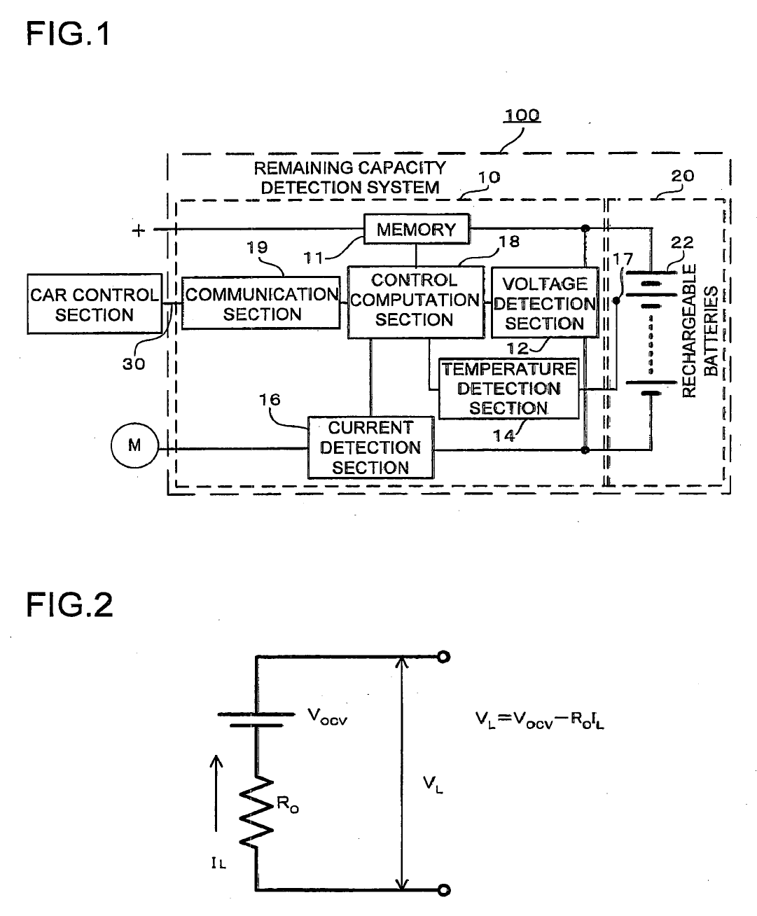

Turning to FIG. 1, a block diagram showing the structure of a power source apparatus related to one form of an embodiment of the present invention is illustrated. The power source apparatus 100 of this figure is provided with a battery unit 20, which includes rechargeable batteries 22, and a remaining capacity detection system 10. The remaining capacity detection system 10 is provided with a voltage detection section 12 to detect battery voltage, a temperature detection section 14 to detect battery temperature, a current detection section 16 to detect battery current flow, a control computation section 18 to operate on signals input from the voltage detection section 12, the temperature detection section 14, and the current detection section 16 and to determine remaining battery capacity and battery unit 20 maximum limiting current values from remaining capacity and battery temperature, and a communication section 19 to send the computed remaining capacity and maximum limiting current values to the connected equipment. The communication section 19 connects to connected equipment communication terminals 30. The communication section 19 connects with the connected equipment via the connected equipment communication terminals 30, and sends signals to the connected equipment indicating remaining capacity and maximum limiting current values. In this example, a vehicle such as a car or automobile is used as the connected equipment, and the power source apparatus 100 is installed on-board the car to power an electric motor M, which drives the car. The communication section 19 connects with, and communicates with a car control section provided in the car. The car power source apparatus is described below.

Rechargeable batteries 22 housed in the battery unit 20 are nickel hydrogen batteries. However, the batteries can also be nickel cadmium batteries or lithium ion rechargeable batteries. The batteries can be a single battery or a plurality of batteries connected in series, in parallel, or in a combination of series and parallel.

The voltage detection section 12 detects the voltage of rechargeable batteries 22 housed in the battery unit 20. Since the battery unit 20 of the figure has a plurality of rechargeable batteries 22 connected in series, the voltage detection section 12 detects the total voltage of all the series connected batteries. The voltage detection section 12 outputs detected voltage as an analog signal to the control computation section 18, or the analog signal is converted to a digital signal via an analog-to-digital converter (A/D converter) and output to the control computation section 18. The voltage detection section 12 detects battery voltage at a fixed sampling rate or continuously, and outputs the detected voltage to the control computation section 18.

The temperature detection section 14 is provided with a temperature sensor 17 to detect the temperature of batteries housed in the battery unit 20. The temperature sensor 17 contacts a battery surface, contacts a battery via heat conducting material, or is in close proximity to a battery surface for thermal connection to detect battery temperature. The temperature sensor 17 is a thermistor. However, any device that can convert temperature to electrical resistance, such as a PTC device or varistor, can be used as the temperature sensor 17. Further, a device that can detect temperature without contact to the battery, such as a device that detects infrared radiation emitted from the battery, can also be used as the temperature sensor 17. The temperature detection section 14 also outputs detected battery temperature as an analog signal to the control computation section 18, or the analog signal is converted to a digital signal via an A/D converter and output to the control computation section 18. The temperature detection section 14 detects battery temperature at a fixed sampling rate or continuously, and outputs the detected battery temperature to the control computation section 18.

The current detection section 16 has a resistive element connected in series with the batteries, and detects the voltage developed across both terminals of that resistive element to detect discharging current flow through the batteries. The resistive element is a low value resistor. However, semiconductors, such as a bipolar transistor or field effect transistor (FET) can also be used as the resistive element. Since the direction of current flow is opposite for battery charging current and discharging current, the polarity of the voltage developed across the resistive element is reversed for charging and discharging. Consequently, the polarity of the voltage across the resistive element can determine if the current is charging current or discharging current, and the amount of the voltage across the resistive element can detect the magnitude of the current. This is because current is proportional to the voltage developed across the resistive element. This type of current detection section 16 can accurately detect discharging current. However, the current detection section 16 can also be a structure that detects current by detecting magnetic flux external to the current flow inside a wire lead. The current detection section 16 also outputs detected discharging current as an analog signal to the control computation section 18, or the analog signal is converted to a digital signal via an A/D converter and output to the control computation section 18. The current detection section 16 detects discharging current at a fixed sampling rate or continuously, and outputs the detected discharging current to the control computation section 18.

An apparatus, which outputs digital signals from the voltage detection section 12, the temperature detection section 14, and the current detection section 16 to the control computation section 18 at a fixed sampling rate, can offset the timing of the digital signal from each detection section to sequentially output the digital signals to the control computation section 18.

The control computation section 18 integrates battery discharging current to determine discharge capacity, and computes remaining battery capacity by subtracting that discharge capacity. For example, if a battery with a full charge capacity of 1000 mAh is discharged for 500 mAh, remaining capacity becomes 50%. Accordingly, as a fully charged battery is discharged, remaining capacity gradually decreases. In addition, the control computation section 18 limits power by limiting the usable amounts of current and voltage as described below. Information such as prescribed values and other data necessary for limiting power are stored in memory 11 connected to the control computation section 18. Non-volatile memory such as E²PROM (electrically erasable programmable memory) or volatile memory such as RAM (random access memory) can be used as the memory 11.

(Method of Controlling Rechargeable Battery Power at Times Other than During Charging and Discharging)

Powering a car via a power source apparatus typically requires accurate detection of remaining battery capacity. In general, remaining battery capacity is computed by detecting charging current and discharging current and integrating those detected currents. This type of method subtracts discharge capacity from charge capacity to compute remaining capacity. Charge capacity is computed by integrating charging current. Discharge capacity is computed by integrating discharging current. A method that computes remaining capacity from charge capacity and discharge capacity can compute remaining capacity when the rechargeable batteries 22 are lithium ion batteries, nickel hydrogen batteries, or nickel cadmium batteries. However, error in the remaining capacity can develop depending on discharging current and battery temperature. The power source apparatus monitors rechargeable battery conditions and, at any given time, specifies the amount of usable power as a maximum current value and maximum voltage value. These maximum current and voltage values are typically determined based on remaining capacity. However, if there is error in determining remaining capacity, computation of these maximum current and voltage values also becomes inaccurate, and depending on battery conditions, charging and discharging can take place while exceeding those maximum current and voltage values. There is then concern that effects such as rise in battery temperature and internal pressure and drop in battery lifetime can result in loss of stability and reliability. Therefore, power is not limited based on remaining rechargeable battery capacity for the present form of embodiment, but rather a method is adopted that computes rechargeable battery open circuit voltage and internal resistance from actual measured values of battery voltage and current, and based on that specifies maximum current values. In the following description, a method is described that limits battery charging and discharging according to voltage.

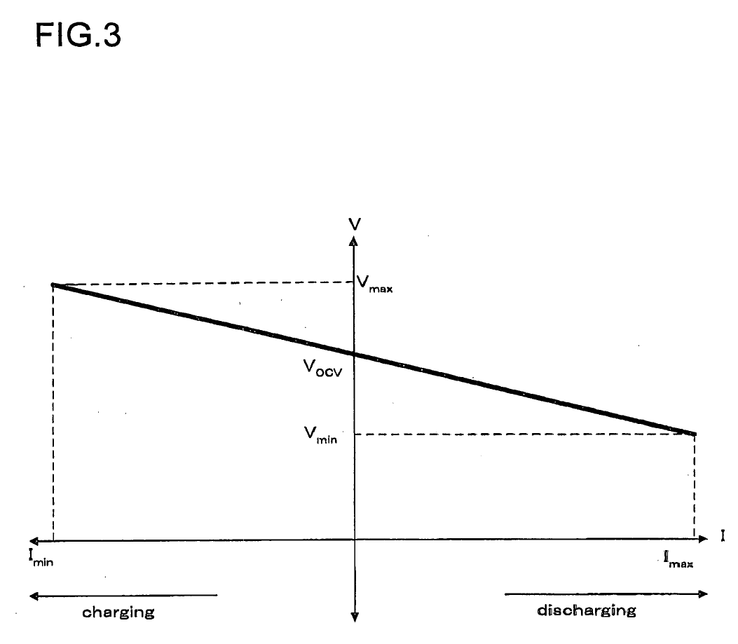

If rechargeable batteries included in the battery unit 20 are approximated by the circuit shown in FIG. 2, battery current I_{L} and battery voltage V_{L} can be expressed in terms of rechargeable battery open circuit voltage V_{OCV} and internal resistance R₀ according to the following equation.
V_{L}=V_{OCV}−R₀I_{L} (9)
If battery unit current-voltage characteristics from the equation above are displayed graphically, they can be represented by a graph of the type shown in FIG. 3. This graph shows the change in battery voltage and current during charging and discharging. The right side of the graph shows discharging and the left side shows charging. Battery current I_{L} and battery voltage V_{L} can be measured. If a plurality of these measurements are made during charging and discharging with the voltage detection section 12 and current detection section 16 of the circuit of FIG. 1, rechargeable battery open circuit voltage V_{OCV} and internal resistance R₀ can be found from simultaneous equations. Open circuit voltage V_{OCV} is equivalent to the no-load open circuit voltage of the battery. The type of straight line relation shown in FIG. 3 can be found by various techniques. For example, if many battery current I_{L} and battery voltage V_{L} measurements are taken, there will be a distribution of measurement values and a straight line will not be formed. In that case, methods such as the method of least squares can be used to find a straight line approximation. Internal resistance R₀ can also be found at a measurement point from ΔI (current differential) and ΔV (voltage differential) by computing internal resistance R₀ as ΔV/ΔI.

As one method of finding rechargeable battery open circuit voltage V_{OCV} and internal resistance R₀, pulse discharge is repeated a plurality of times when the car is not being driven. Discharging current and discharging voltage are detected, and open circuit voltage V_{OCV} and internal resistance R₀ are calculated based on the discharging current I_{L} and discharging voltage V_{L}. When the car is being driven, discharging and charging depend on driving conditions, and it is difficult to obtain favorable conditions for computing open circuit voltage V_{OCV} and internal resistance R₀. (Favorable conditions allow a plurality of internal resistance R₀ computations while current values are changing during discharge.) In this method, since the car is not being driven and pulse discharge is repeated a plurality of times, stable values of open circuit voltage V_{OCV} and internal resistance R₀ can be obtained. Another method to find open circuit voltage V_{OCV} and internal resistance R₀ is to pre-store a table of internal resistance R₀ as a function of temperature and use a value from that table as an initial value. Then, open circuit voltage V_{OCV} and internal resistance R₀ are periodically computed and up-dated. For example, each value is up-dated according to prescribed timing, such as the value of open circuit voltage V_{OCV} is up-dated every 0.1 sec, and the value of internal resistance R₀ is updated every time discharge occurs.

Here, a minimum voltage Vₘᵢₙ to prevent over-discharging and a maximum voltage Vₘₐₓ to prevent over-charging are set. The minimum voltage Vₘᵢₙ and maximum voltage Vₘₐₓ are optimum values determined according to factors such as the type and characteristics of the rechargeable batteries being used. Next, a limiting discharging current Iₘₐₓ and a limiting charging current Iₘᵢₙ are found from the intersections of the minimum voltage Vₘᵢₙ and maximum voltage Vₘₐₓ with the straight line of FIG. 3. Based on these values, the control computation section 18 limits charging and discharging such that discharging current greater than or equal to Iₘₐₓ and/or charging current less than or equal to Iₘᵢₙ (that is, charging current greater than or equal in magnitude to Iₘᵢₙ) does not flow through the rechargeable batteries. The limiting discharging current Iₘₐₓ and a limiting charging current Iₘᵢₙ obtained from FIG. 3 can be computed from the equations
Iₘₐₓ=(V_{ocv}−Vₘᵢₙ)/R₀
Iₘᵢₙ=(Vₘₐₓ−V_{ocv})/R₀.
The reason limiting discharging current Iₘₐₓ and a limiting charging current Iₘᵢₙ can be found from FIG. 3 and the equations above is as follows. In considering the allowable range of current measured after a prescribed time, or at the next period after a time with voltage V_{OCV} and no charging or discharging, the allowable range of voltage should not exceed the minimum voltage Vₘᵢₙ or the maximum voltage Vₘₐₓ. Specifically, maximum voltage differences of V_{ocv}−Vₘᵢₙ and Vₘₐₓ−V_{ocv} are only allowed. Maximum current, corresponding to those maximum voltage differences, flows when the load is short circuited. Since resistance in the short circuited condition is only the internal battery resistance R₀, maximum limiting discharging current Iₘₐₓ and limiting charging current Iₘᵢₙ values can be found as described above from the equations
Iₘₐₓ=(V_{ocv}−Vₘᵢₙ)/R₀
Iₘᵢₙ=(Vₘₐₓ−V_{ocv})/R₀.

(Method of Controlling Rechargeable Battery Power During Charging and Discharging)

The description above is a method of computing maximum allowable discharging and charging current values when no discharging or charging is in progress. Specifically, the method described above is applicable for finding the maximum discharging current value from the point where discharging current is 0 A, and for finding maximum charging current magnitude from the point where charging current is 0 A. However, the method described above may not be able to accurately compute maximum allowable discharging and charging currents in the middle of discharging or charging. In particular, the value of open circuit voltage V_{OCV} and internal resistance R₀ may change during discharging and charging, and battery current and voltage may become points that do not fall on the straight line current-voltage characteristics of FIG. 3. Methods that compute maximum values of discharging and charging current during discharging and charging are described in order in the following.

(Method of Controlling Rechargeable Battery Power During Discharging)

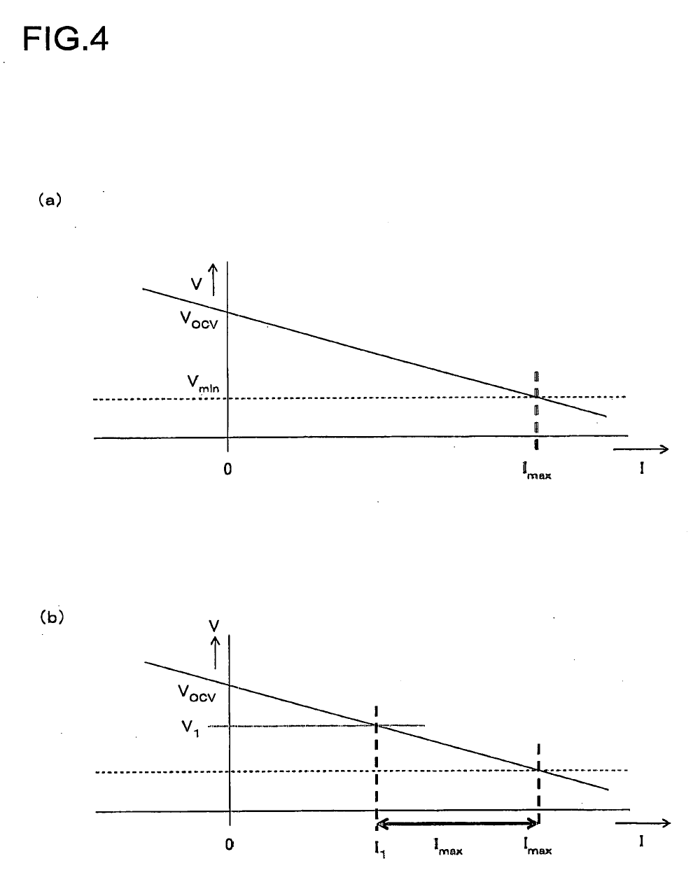

FIG. 4 shows a method of computing the limiting discharging current during discharging. Similar to FIG. 3, FIG. 4 (a) shows a method of determining maximum limiting discharging current Iₘₐₓ at a point where no discharging takes place, that is at the point where discharging current is 0 A. FIG. 4 (b) shows a method of determining maximum limiting discharging current Iₘₐₓ₁ during discharging. From FIG. 4 (a), a straight line describing current-voltage characteristics is determined as previously described, and the maximum limiting discharging current Iₘₐₓ is obtained from the intersection of the minimum discharging voltage Vₘᵢₙ with the straight line. In the example of FIG. 4, battery voltage V₁ is detected during discharging by the voltage detection section 12 at the current I₁. As shown in FIG. 4 (b), the point (I₁, V₁) lies on the straight line described by equation (9) and the current value I₁ can be found from the value of V₁ on the straight line. From that point, the allowable range of discharging current measured after a prescribed time, or at the next period after that point, can be determined as follows. At that point, the allowable range of voltage should not exceed the minimum voltage Vₘᵢₙ. From FIG. 4 (b), the maximum allowable voltage difference of V₁−Vₘᵢₙ is only allowed, and the maximum limiting discharging current Iₘₐₓ₁ becomes (Iₘₐₓ−I₁). In terms of equations, the current that allows the maximum voltage difference V₁−Vₘᵢₙ is that value divided by the internal resistance R₀ or
Iₘₐₓ₁=(V₁−Vₘᵢₙ)/R₀.
Therefore, at that point, the maximum limiting discharging current Iₘₐₓ₁ can be computed from (Iₘₐₓ−I₁). In the example of FIG. 4 (b), discharging current is kept at a value less than (Iₘₐₓ−I₁), and rechargeable batteries can be protected by controlling discharging current with that value as an upper limit.

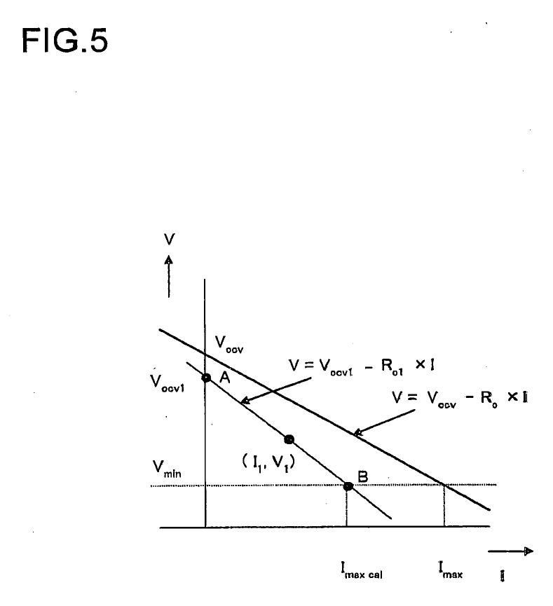

Next, the case where internal resistance and open circuit voltage are up-dated during discharging is described. In FIG. 5, current I₁ is detected by the current detection section 16 and battery voltage V₁ is detected by the voltage detection section 12 during discharging. As shown in FIG. 5, the point (I₁, V₁) does not lie on the straight line described by equation (9), and if the internal resistance at that point is R₀₁, a new open circuit voltage V_{OCV1} can be calculated from equation (9) as follows.
V_{OCV1}=V₁+R₀₁I₁ (10)
In terms of FIG. 5, this is the intersection point A of a straight line extending through the point (I₁, V₁) with a slope of R₀₁ and the vertical axis V. An up-dated limiting discharging current I_{max cal} can be obtained by substituting the new value V_{OCV1} into
I_{max cal}=(V_{OCV1}−Vₘᵢₙ)/R₀₁.
In terms of FIG. 5, this is the intersection point B of the straight line extending through the point (I₁, V₁) and the horizontal line V=Vₘᵢₙ. In this fashion, the straight line that can be described by equation (9) is up-dated. In the same manner described previously, updated values of the maximum limiting discharging current Iₘₐₓ₁ during discharging and the maximum limiting discharging current Iₘₐₓ with no discharging or charging can be obtained.

(Method of Controlling Rechargeable Battery Power During Charging)

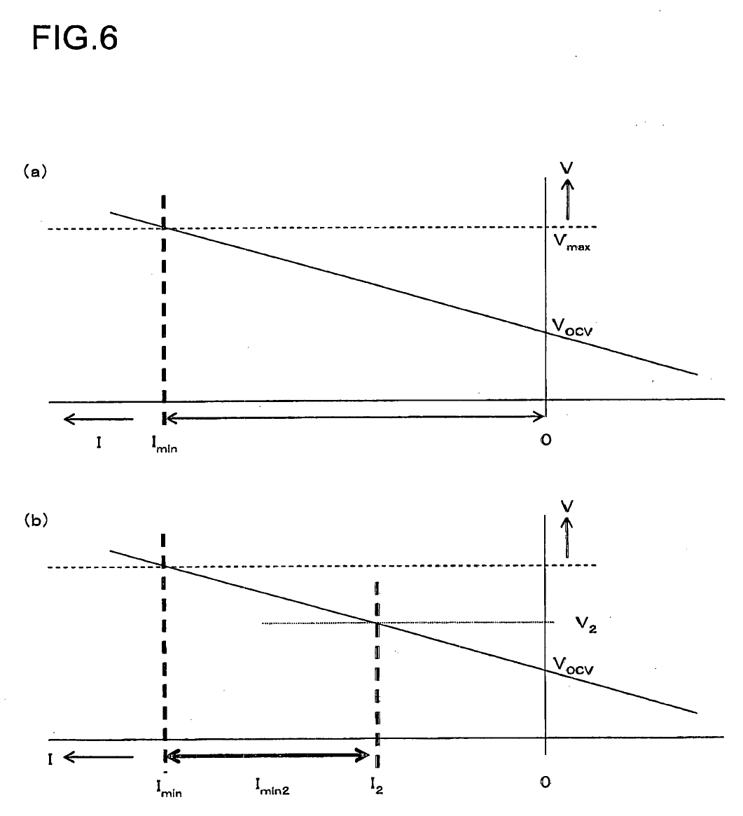

FIG. 6 shows a method of computing the limiting charging current during charging. Similar to FIG. 3, FIG. 6 (a) shows a method of determining limiting charging current Iₘᵢₙ with maximum magnitude at a point where no charging takes place, that is at the point where charging current is 0 A. FIG. 6 (b) shows a method of determining limiting charging current Iₘᵢₙ₁ with maximum magnitude during charging. From FIG. 6 (a), a straight line describing current-voltage characteristics is determined as previously described, and the limiting charging current Iₘᵢₙ with maximum magnitude is obtained from the intersection of the maximum charging voltage Vₘₐₓ with the straight line. In the example of FIG. 6, battery voltage V₂ is detected during charging by the voltage detection section 12 at the current I₂. As shown in FIG. 6 (b), the point (I₂, V₂) lies on the straight line described by equation (9) and the current value I₂ can be found from the value of V₂ on the straight line. From that point, the allowable range of charging current magnitude measured after a prescribed time, or at the next period after that point, can be determined as follows. At that point, the allowable range of voltage should not exceed the maximum voltage Vₘₐₓ. From FIG. 6 (b), the maximum allowable voltage difference of Vₘₐₓ−V₂ is only allowed, and the limiting charging current Iₘᵢₙ₂ with maximum magnitude becomes (Iₘᵢₙ−I₂). In terms of equations, the magnitude of the current that allows the maximum voltage difference Vₘₐₓ−V₂ is that value divided by the internal resistance R₀ or
|Iₘᵢₙ₂|=(Vₘₐₓ−V₂)/R₀.
Therefore, rechargeable batteries can be protected by controlling the charging current with the magnitude of Iₘᵢₙ₂ as an upper limit.

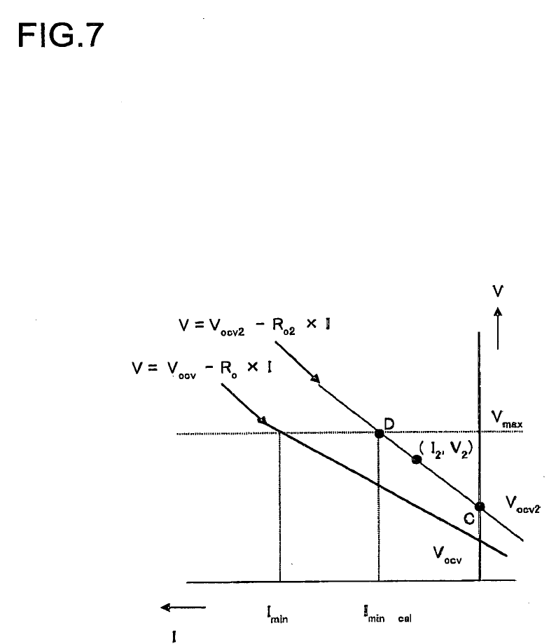

Next, the case where internal resistance and open circuit voltage are up-dated during charging is described. In FIG. 7, current I₂ is detected by the current detection section 16 and battery voltage V₂ is detected by the voltage detection section 12 during charging. As shown in FIG. 7, the point (I₂, V₂) does not lie on the straight line described by equation (9), and if the internal resistance at that point is R₀₂, a new open circuit voltage V_{OCV2} can be calculated from equation (9) as follows.
V_{OCV2}=V₂+R₀₂I₂ (11)
In terms of FIG. 7, this is the intersection point C of a straight line extending through the point (I₂, V₂) with a slope of R₀₂ and the vertical axis V. An up-dated limiting charging current I_{min cal} magnitude can be obtained by substituting the new value V_{OCV2} into
|I_{min cal}|=(Vₘₐₓ−V_{OCV2})/R₀₂.
In terms of FIG. 7, this is the intersection point D of the straight line extending through the point (I₂, V₂) and the horizontal line V=Vₘₐₓ. In this fashion, the straight line that can be described by equation (9) is up-dated. In the same manner described previously, updated values of the limiting charging current of maximum magnitude Iₘᵢₙ₂ during charging and the limiting charging current of maximum magnitude Iₘᵢₙ with no charging or discharging can be obtained.

According to the method of the embodiment above, limiting current values are computed to limit the amount of power without computing remaining rechargeable battery capacity. Therefore, highly reliable and stable power limiting can be performed that is not subject to the effects of errors in estimating remaining capacity. Further, in the case where power is limited based only on remaining capacity, as a correction for errors in that remaining capacity, results from the method described above can be compared and the more conservative approach can be adopted.

In the examples above, battery characteristics were approximated by a straight line. However, it is also possible to approximate those characteristics with a second order curve, third order curve, or higher order curve.

The control computation section 18 computes limiting power based on maximum magnitude charging and discharging currents as computed above, and controls charging and discharging such that power exceeding the limiting value is not used. For example, if the control computation section 18 computes maximum magnitude charging and discharging currents at a given time, it then controls charging and discharging currents such that they do not increase above those values. Consequently, the control computation section 18 can acquire the allowable current limit, and can limit current within that range to utilize rechargeable batteries with safety.

The amount of maximum usable power can be found as follows. As described previously, a minimum voltage Vₘᵢₙ to prevent over-discharging and a maximum voltage Vₘₐₓ to prevent over-charging are set. A limiting discharging current Iₘₐₓ and a limiting charging current Iₘᵢₙ are found based on FIG. 3. At the point of zero current or a point during discharging, the maximum allowable amount of power during discharging P_{limd} after a prescribed time, or at the next period after that point, can be computed from battery current I_{L}, battery voltage V_{L}, rechargeable battery open circuit voltage V_{OCV}, and internal resistance R₀ by the equation
P_{limd}=Vₘᵢₙ*(V_{L}−Vₘᵢₙ)/R₀. (12)

In addition, at the point of zero current or a point during charging, the maximum allowable amount of power during charging P_{limc} can be computed from the following equation
P_{limc}=Vₘₐₓ*(Vₘₐₓ−V_{L})/R₀. (13)

From these equations, the amount of power can be calculated that is likely to cause a voltage limit to be reached in the next instant, which is after a prescribed time or at the prescribed next period, from the present state.

The method of controlling rechargeable battery power and power source apparatus of the present invention is suitable for application as a high current, high output voltage power source apparatus such as a car power source apparatus in a hybrid car or electric automobile.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within the metes and bounds of the claims or equivalence of such metes and bounds thereof are therefore intended to be embraced by the claims. This application is based on Application No. 2004-313242 filed in Japan on Oct. 28, 2004, the content of which is incorporated hereinto by reference.

What is claimed is:

1. A method of controlling rechargeable battery power wherein limiting the amount of usable power during rechargeable battery charging and discharging is included; comprising the steps of:
determining a rechargeable battery current-voltage characteristic function based on rechargeable battery charging and discharging current flow and charging and discharging voltage;
finding a limiting discharging current Iₘₐₓ and/or a limiting charging current Iₘᵢₙ from a prescribed minimum voltage Vₘᵢₙ to prevent over-discharging and/or a prescribed maximum voltage Vₘₐₓ to prevent over-charging, and their intersection with said current-voltage characteristic function; and
controlling current such that discharging current greater than or equal to Iₘₐₓ and/or charging current less than or equal to Iₘᵢₙ does not flow through the rechargeable batteries.

2. A method of controlling rechargeable battery power wherein limiting the amount of usable power during rechargeable battery charging and discharging is included; comprising the steps of:
measuring rechargeable battery charging and discharging current flow I_{L} and charging and discharging voltage V_{L};
based on that, calculating rechargeable battery open circuit voltage V_{OCV} and internal resistance R₀;
finding a limiting discharging current Iₘₐₓ and/or a limiting charging current Iₘᵢₙ from a prescribed minimum voltage Vₘᵢₙ to prevent over-discharging and/or a prescribed maximum voltage Vₘₐₓ to prevent over-charging, and their intersection with the straight line represented by the equation
V_{L}=V_{OCV}−R₀I_{L} (1); and
controlling current such that discharging current greater than or equal to Iₘₐₓ and/or charging current less than or equal to Iₘᵢₙ does not flow through the rechargeable batteries.

3. A method of controlling rechargeable battery power as recited in claim 2 further comprising the steps of:
periodically measuring rechargeable battery discharging voltage V₁ and discharging current I₁ during discharging;
up-dating open circuit voltage V_{OCV} with the equation
V_{OCV}=V_{L}+R₀I_{L} (2)
obtained from said equation (1);
finding a limiting discharging current Iₘₐₓ from a prescribed minimum voltage Vₘᵢₙ to prevent rechargeable battery over-discharging, and its intersection with equation (1) reflecting the up-dated V_{OCV}; and
controlling current such that discharging current greater than or equal to Iₘₐₓ does not flow through the rechargeable batteries.

4. A method of controlling rechargeable battery power as recited in claim 2 further comprising the steps of:
periodically measuring rechargeable battery charging voltage V₂ and charging current I₂ during charging;
up-dating open circuit voltage V_{OCV} with the equation (2);
finding a limiting charging current Iₘᵢₙ from a prescribed maximum voltage Vₘₐₓ to prevent rechargeable battery over-charging, and its intersection with equation (1) reflecting the up-dated V_{OCV}; and
controlling current such that charging current greater than or equal in magnitude to Iₘᵢₙ does not flow through the rechargeable batteries.

5. A method of controlling rechargeable battery power as recited in claim 2 further comprising the step of:
computing maximum allowable discharging power P_{limd} at a given point during discharging from computed rechargeable battery open circuit voltage V_{OCV} and internal resistance R₀, and the following equation
P_{limd}=Vₘᵢₙ*(V_{OCV}−Vₘᵢₙ)/R₀. (3)

6. A method of controlling rechargeable battery power as recited in claim 3 further comprising the step of:
computing maximum allowable discharging power P_{limd} at a given point during discharging from computed rechargeable battery open circuit voltage V_{OCV} and internal resistance R₀, and the following equation
P_{limd}=Vₘᵢₙ*(V_{OCV}−Vₘᵢₙ)/R₀. (3)

7. A method of controlling rechargeable battery power as recited in claim 4 further comprising the step of:
computing maximum allowable discharging power P_{limd} at a given point during discharging from computed rechargeable battery open circuit voltage V_{OCV} and internal resistance R₀, and the following equation
P_{limd}=Vₘᵢₙ*(V_{OCV}−Vₘᵢₙ)/R₀. (3)

8. A method of controlling rechargeable battery power as recited in claim 2 further comprising the step of:
computing maximum allowable charging power P_{limc} at a given point during charging from computed rechargeable battery open circuit voltage V_{OCV} and internal resistance R₀, and the following equation
P_{limc}=Vₘₐₓ*(Vₘₐₓ−V_{OCV})/R₀. (4)

9. A method of controlling rechargeable battery power as recited in claim 3 further comprising the step of:
computing maximum allowable charging power P_{limc} at a given point during charging from computed rechargeable battery open circuit voltage V_{OCV} and internal resistance R₀, and the following equation
P_{limc}=Vₘₐₓ*(Vₘₐₓ−V_{OCV})/R₀. (4)

10. A method of controlling rechargeable battery power as recited in claim 4 further comprising the step of:
computing maximum allowable charging power P_{limc} at a given point during charging from computed rechargeable battery open circuit voltage V_{OCV} and internal resistance R₀, and the following equation
P_{limc}=Vₘₐₓ*(Vₘₐₓ−V_{OCV})/R₀. (4)

11. A method of controlling rechargeable battery power as recited in claim 1 wherein
repeatedly pulse discharging rechargeable batteries a plurality of times when the batteries are not driving connected equipment, to detect discharging current and discharging voltage; and
up-dating the value of rechargeable battery open circuit voltage V_{OCV} and internal resistance R₀ based on the discharging current I_{L} and discharging voltage V_{L}.

12. A method of controlling rechargeable battery power as recited in claim 2 wherein
repeatedly pulse discharging rechargeable batteries a plurality of times when the batteries are not driving connected equipment, to detect discharging current and discharging voltage; and
up-dating the value of rechargeable battery open circuit voltage V_{OCV} and internal resistance R₀ based on the discharging current I_{L} and discharging voltage V_{L}.

13. A method of controlling rechargeable battery power as recited in claim 3 wherein
repeatedly pulse discharging rechargeable batteries a plurality of times when the batteries are not driving connected equipment, to detect discharging current and discharging voltage; and
up-dating the value of rechargeable battery open circuit voltage V_{OCV} and internal resistance R₀ based on the discharging current I_{L} and discharging voltage V_{L}.

14. A method of controlling rechargeable battery power as recited in claim 4 wherein
repeatedly pulse discharging rechargeable batteries a plurality of times when the batteries are not driving connected equipment, to detect discharging current and discharging voltage; and
up-dating the value of rechargeable battery open circuit voltage V_{OCV} and internal resistance R₀ based on the discharging current I_{L} and discharging voltage V_{L}.

15. A method of controlling rechargeable battery power as recited in claim 5 wherein
repeatedly pulse discharging rechargeable batteries a plurality of times when the batteries are not driving connected equipment, to detect discharging current and discharging voltage; and
up-dating the value of rechargeable battery open circuit voltage V_{OCV} and internal resistance R₀ based on the discharging current I_{L} and discharging voltage V_{L}.

16. A method of controlling rechargeable battery power as recited in claim 6 wherein
repeatedly pulse discharging rechargeable batteries a plurality of times when the batteries are not driving connected equipment, to detect discharging current and discharging voltage; and
up-dating the value of rechargeable battery open circuit voltage V_{OCV} and internal resistance R₀ based on the discharging current I_{L} and discharging voltage V_{L}.

17. A power source apparatus comprising:
a battery unit provided with a plurality of rechargeable batteries;
a voltage detection section to detect the voltage of rechargeable batteries included in the battery unit;
a temperature detection section to detect the temperature of rechargeable batteries included in the battery unit;
a current detection section to detect the current flow through rechargeable batteries included in the battery unit;
a control computation section to operate on signals input from the voltage detection section, the temperature detection section, and the current detection section and to determine rechargeable battery maximum limiting current values; and
a communication section to send remaining capacity and maximum limiting current values computed by the control computation section to the connected equipment;
wherein the control computation section determines a rechargeable battery current-voltage characteristic function based at least on either rechargeable battery charging and discharging current flow or charging and discharging voltage;
wherein a limiting discharging current Iₘₐₓ and/or a limiting charging current Iₘᵢₙ is calculated from a prescribed minimum voltage Vₘᵢₙ to prevent over-discharging and/or a prescribed maximum voltage Vₘₐₓ to prevent over-charging, and their intersection with said current-voltage characteristic function; and
wherein current is controlled such that discharging current greater than or equal to Iₘₐₓ and/or charging current less than or equal to Iₘᵢₙ does not flow through the rechargeable batteries.
